(19) United States
(12) Patent Application Publication
(10) Pub. No.: US 2009/0241895 A1
(43) Pub. Date: Oct. 1, 2009

(54) TWO STROKE COMBUSTION ENGINE WITH LIQUID INJECTION

(76) Inventor: Mats Hedman, Eskilstuna (SE)

Correspondence Address: KEVIN FARRELL;PIERCE ATWOOD, ONE NEW HAMPSHIRE AVENUE, PORTSMOUTH, NH, 03801, US

(21) Appl. No.: 12/162,005

(22) PCT Filed: Jan. 31, 2007
(86) PCT No.: PCT/SE07/50049

§ 371 Date: Dec. 12, 2008

(30) Foreign Application Priority Data
Jan. 31, 2006 (SE) 0600198-6

(51) Int. Cl. F02B 47/02; F02B 25/18

(52) U.S. Cl. 123/25 C; 123/65 R

(57) ABSTRACT

A combustion engine operating in accordance with the two-stroke principle, which comprises alternating power strokes and the compression strokes, wherein the combustion engine comprises at least one cylinder (1) and a piston (2) that performs a reciprocating motion in said cylinder (1), and a combustion chamber (3) delimited by said cylinder (1) and said piston (2), and at least one inlet (13) for the introduction of combustion air into the combustion chamber (3), and at least one outlet (14) for the discharge of exhaust gases from the combustion chamber (3). The engine comprises means (6, 7, 8) for the injection of a liquid other than fuel into the combustion chamber (3) before or during one and the same compression stroke, wherein said means (6, 7, 8) comprises a valve for the injection of said liquid into the combustion chamber (3) and a control unit (8) with a software provided to open the valve (6) in order to inject said liquid, before or during one and the same compression stroke, in connection with the ending of the discharge of exhaust gases out of the combustion chamber (3) and before the start of the introduction of air into the combustion chamber (3).

### TECHNICAL FIELD

The present invention relates to a method for the operation of a combustion engine that operates in accordance with the two stroke principle, comprising alternating power strokes and compression strokes, wherein the combustion engine comprises at least one cylinder and a piston that reciprocates in said cylinder, and a combustion chamber delimited by said cylinder and the piston, and at least one inlet for an introduction of combustion air into the combustion chamber, and at least one outlet for the discharge of exhaust gases from the combustion chamber.

The invention also relates to a combustion engine that operates according to the two stroke principle, said principle comprising alternating power strokes and compression strokes, wherein the combustion engine comprises at least one cylinder and a piston that reciprocates in said cylinder, and a combustion chamber delimited by said cylinder and said piston, and at least one inlet for the introduction of combustion air into the combustion chamber, and at least one outlet for the discharge of exhaust gases from the combustion chamber.

The inlet and/or the outlet is, preferably, provided with a freely operable valve, but could, as an alternative, comprise a port which is opened and closed by the passing piston, said port being provided in the cylinder wall, preferably in the area of the lower dead centre of the piston. The freely operable valves are, preferably, controlled by a computer-based control system that, for example, may form part of an existing control system used for the control of the ignition and injection of fuel, water, water steam, etc. into the combustion chamber.

In said cylinder, the piston reciprocates between two end positions, an upper and a lower end position respectively. Here, the motion of the piston from the upper end position to the lower end position is defined as a power stroke, and the motion of the piston from the lower end position to the upper end position is defined as a compression stroke. When the engine operates, combustion is initiated in connection to the ending of the compression stroke, and the combustion gases are evacuated in connection to the ending of the power stroke.

The discharge of exhaust gases is assumed to start and end simultaneously with the opening and the closure respectively of the corresponding valve or valves. In a corresponding way, the inlet of air is assumed to start and end simultaneously with the opening and closure respectively of the corresponding valve or valves. The same assumption is made for the introduction of said liquid, which may be performed through a separate valve or a separate nozzle.

### THE BACKGROUND OF THE INVENTION

HCCI, Homogeneous Charge Compression Ignition, is a well known principle for the operation of combustion engines. During HCCI and high load operation there are problems, since the ignition takes place too early, due to an excessive raising of temperature.

Furthermore there is a general desire to obtain minimum emissions of nitrogen oxides, NOx, during operation of combustion engines.

Generally, from an efficiency point of view, it is also desirable to enable the introduction of a larger amount of combustion air than would otherwise be possible by means of a lowering of the temperature and the pressure in the combustion chamber.

These different requests are already known and form the basis of the present invention.

### THE OBJECT OF THE INVENTION

The object of the present invention, in connection with two stroke operation of the kind initially described, and in particular HCCI, is to provide a relative lowering of the temperature and the pressure in the combustion chamber in order to permit the introduction of a larger amount of oxidation fluid, for example air, into the combustion chamber and/or in order to inhibit a too early ignition, and in order to enable a decrease in the amount of NOx of the exhaust gases after combustion.

### SUMMARY OF THE INVENTION

The object of the invention is achieved by means of the initially defined method, characterized in that, before or during one and the same compression stroke, a liquid other than fuel is injected into the combustion chamber in connection with the ending of a discharge of exhaust gases out of the combustion chamber and before the start of the introduction of air into the combustion chamber. The liquid is of such a kind that it will fully or partly evaporate under the pressure and at the temperature that exists in the combustion chamber during the injection moment. In order to achieve this result, the amount of liquid, the temperature of the liquid or the composition thereof may be regulated. Preferably, the liquid is to a major part comprised by water. The invention defines a certain sequence by which at least the beginning of the discharge of exhaust gases precedes the beginning of the introduction of fresh air. A high pressure will exist in the combustion chamber when the piston reaches its lower dead centre, and at this stage exhaust gases will be able to leave through the outlet valve, which, preferably, is provided in the cylinder head. Subsequently, or in connection therewith, the liquid is injected. As the liquid is permitted to evaporate, the temperature, and thereby the pressure, in the combustion chamber will decrease. Thanks to the lowering of the temperature, a larger amount of fresh air of a given pressure can be introduced during the subsequent step. Accordingly, a more efficient gas exchange is achieved. The liquid is assumed to be injected during the compression stroke but not during that part thereof during which the very compression takes place, which is exactly what prior art suggests. However, one of the dependent claims in the present invention specifies this possibility, however only as a supplement to this first injection.

The heat in the remaining combustion gases will provide for a momentary evaporation of the liquid and a simultaneous cooling of the combustion gases, resulting in a lowering of the pressure. Thereby, a larger mass of air can be introduced. By means of a regulation of the mass of the introduced liquid, the mean temperature of the gases in the combustion chamber can be controlled to a requested level. Of reasons explained earlier this is, in particular, an advantage during HCCI. If, for example, the liquid contains water, an evaporation of water is achieved. An advantage of such an evaporation and a subsequent cooling is the reduction of the formation of nitrogen oxides, NOx, during the combustion. The steam has the same effect as EGR, Exhaust Gas Recirculation, which is a common method of decreasing the generation of NOx. By controlling the mass of the added liquid, it will be possible to control the generation of NOx. When diesel oil is used as the fuel, both the generation of NOx and soot can be reduced, which is advantageous. Any remaining, non-evaporated liquid that is evaporated during a later part of the compression stroke will reduce the compression work by means of the heat that is transmitted away, thereby resulting in improved efficiency and, possibly, a further reduction of the generation of NOx. The addition of a liquid, suitably by means of injection of a spray, assumes that there are means arranged for this purpose in, or in connection to, the combustion engine in question.

Preferred embodiments of the invention include the start of the injection of the liquid being begun within 20 crank angle degrees, preferably 10 crank angle degrees, and preferably 5 crank angle degrees from the moment when the discharge of exhaust gases out of the combustion chamber is ended.

Preferably, the injection of the liquid is initiated after, preferably immediately after, or even at the same moment as the discharge of exhaust gases out of the combustion chamber is ended. The technical effect of the injection will thereby be the best.

However, the injection of the liquid might begin during the time when there is still a discharge of exhaust gases. This may, in particular at high rotational speeds, be preferred in order to obtain a maximum technical effect. At high rotational speeds the time period between the closure of the outlet valve and the opening of the inlet valve will be shorter, and even negative, i.e. there will be an overlap between inlet and discharge, which might make it necessary to let the injection of the liquid overlap either the discharge of exhaust gases or the introduction of air or both. It might even be conceived to let the closure of the outlet valve occur after the closure of the inlet valve.

According to one embodiment, the method is characterized in that the introduction of the air into the combustion chamber is initiated while the injection of the liquid is still going on.

It is preferred that the injection of the liquid into the combustion chamber is ended before the introduction of air into the combustion chamber is ended. At the very latest, the injection of the liquid into the combustion chamber should be ended simultaneously with the ending of the introduction of the air into the combustion chamber.

The introduction of a fuel to the combustion chamber may take place simultaneously with the injection of said liquid, and an introduction of a fuel to the combustion chamber may be done through the same valve as the one through which said liquid is injected.

According to one embodiment, said liquid is injected together with an alcohol. Preferably, the alcohol will thereby form at least a part of the fuel that is to be combusted during the power stroke that follows the compression stroke.

According to another embodiment, a fuel is introduced into the combustion chamber simultaneously with the introduction of the air. For example, this is the case during HCCI. It is also possible that the fuel be introduced separately at a later stage of the compression stroke.

According to a further embodiment of the invention, a second injection of a liquid other than fuel is performed during the compression stroke, when the introduction of the air to the combustion chamber has ended. This liquid may be of the same type or of another type than the previously injected liquid, and is likewise supposed to be evaporated and to lower the temperature and the pressure in the combustion chamber in order to reduce the remaining compression work, and thereby to improve the efficiency.

Regardless of whether it is the first or second injection of liquid, the latter preferably comprises water. Before the liquid is introduced into the compression chamber it is pressurized and heated to such a degree that at least a part of the droplets of the spray will explode spontaneously upon entrance into the compression chamber.

The object of the invention is also achieved with a combustion chamber as initially defined, characterized in that it comprises means to, before or during one and the same compression stroke, inject a liquid other than fuel into the combustion chamber, and a control unit with a software arranged so as to open the valve in order to, before or during one and the same compression stroke, inject said liquid in connection to the ending of a discharge of exhaust gases out of the combustion chamber and before the introduction of air into the combustion chamber is started.

Said means may comprise a valve for the injection of said fuel, said valve then preferably being an operable valve, for example a pneumatically, hydraulically or electromagnetically operated valve. Furthermore, said means may comprise a control unit, with a software arranged so as to control the opening and closure of said valve in accordance with the suggested, inventive method.

Preferably, the inlet and outlet valves are so called operable valves, that is valves that are not mechanically connected to the crank shaft, but freely operable regardless of the crank shaft position. Accordingly, operable valves are referred to as valves to the combustion chamber of an engine cylinder, said valves being opened and closed through, for example, the action of a pressurized fluid, upon basis on signals from a computer-based, preferably electronic, control system.

Further features of and advantages of the present invention will be presented in the following, detailed description and the annexed drawing.

### BRIEF DESCRIPTION OF THE DRAWINGS

The invention will now, by way of example, be described with reference to the annexed drawing, on which:

FIG. 1 is a schematic representation of a part of a combustion engine according to the invention,

FIG. 2 is a representation of a time schedule for the steps of an embodiment of the inventive method, and

FIG. 3 is a representation of a time schedule of the steps of a further embodiment of the inventive method.

### DETAILED DESCRIPTION OF PREFERRED EMBODIMENTS

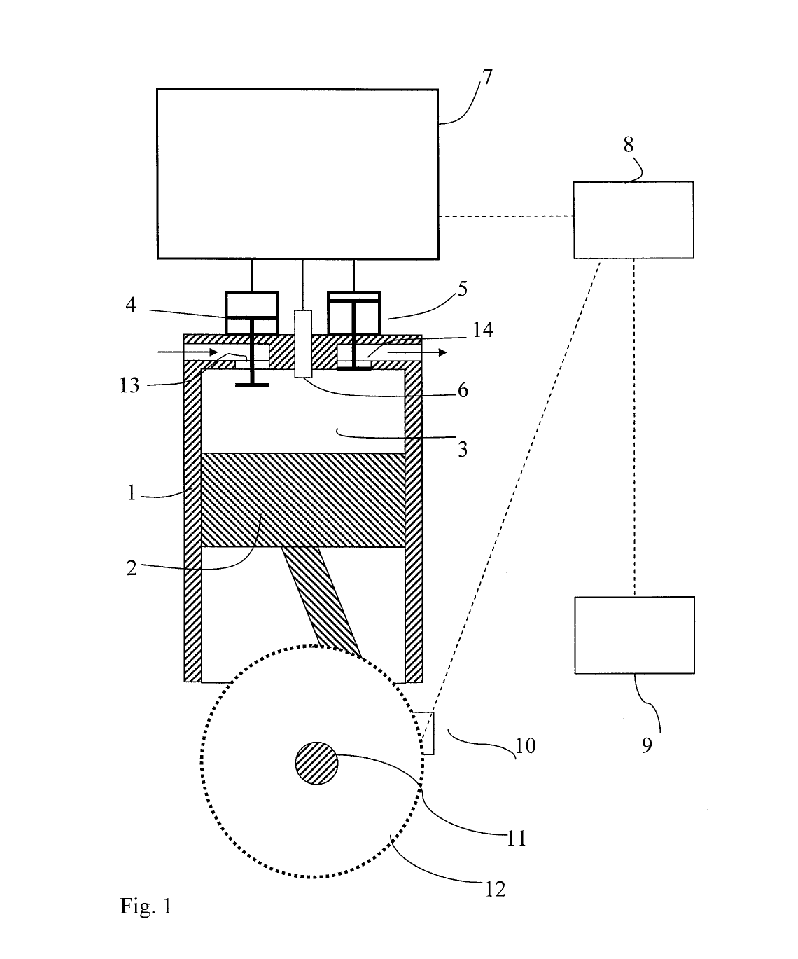

FIG. 1 schematically shows a part of a combustion engine according to the invention. Preferably, the combustion engine is arranged to propel a vehicle, such as a car, a bus or a lorry. It comprises a cylinder 1, a piston 2 provided to move reciprocatingly in the latter, a combustion chamber 3 delimited by the cylinder and the piston, an inlet valve 4, an outlet valve 5 and a valve or a nozzle 6 for the injection of a liquid other than fuel. It is also conceivable that the nozzle 6 may be used in order to, besides injecting said liquid, also inject at least a part of a fuel, such as an alcohol, such as ethanol. An exhaust gas system or the like may be connected to the outlet at which the outlet valve 5 is arranged.

In the figure, the piston 2 is under motion during a compression stroke in a two-stroke cycle, and air, possibly together with fuel, is flowing into the combustion chamber through the open inlet valve 3. The outlet valve 4 has just, when the piston 2 was in its lower dead centre position, opened, but is now closed.

A circuit 7 is used for the operation of actuators to the valves 4 and 5 and the nozzle 6. A control unit 8 is operatively connected to the circuit 7 in order to provide for signal control of the circuit 7 and the valves 4 and 5 and the nozzle 6 connected to said circuit. The circuit 7 may comprise electric components and a pressure fluid circuit, preferably a pneumatic pressure fluid circuit. For example, it may comprise pilot valves, not shown, that are driven by electromagnets, for the purpose of controlling the flow of a pressure fluid, such as air, to actuator chambers, not shown, in order to operate actuator pistons arranged therein, by means of which the inlet valves 4 and the inlet valves 5 are driven.

A member 9, for example a gas pedal, is operatively connected to the control unit 8 in order to provide for the ordering of a torque. A sensor 10, adjacent to a graded plate 12 arranged on the crank shaft 11, is operatively connected to the control unit 8 and continuously gives information to the control unit 8 about rotational speed and the crank shaft position and/or the position of the piston 2 in the cylinder 1. The control unit 8 decides when the operable valves 4 and 5 are to open or close and when the nozzle 6 is to open for the injection of said fluid.

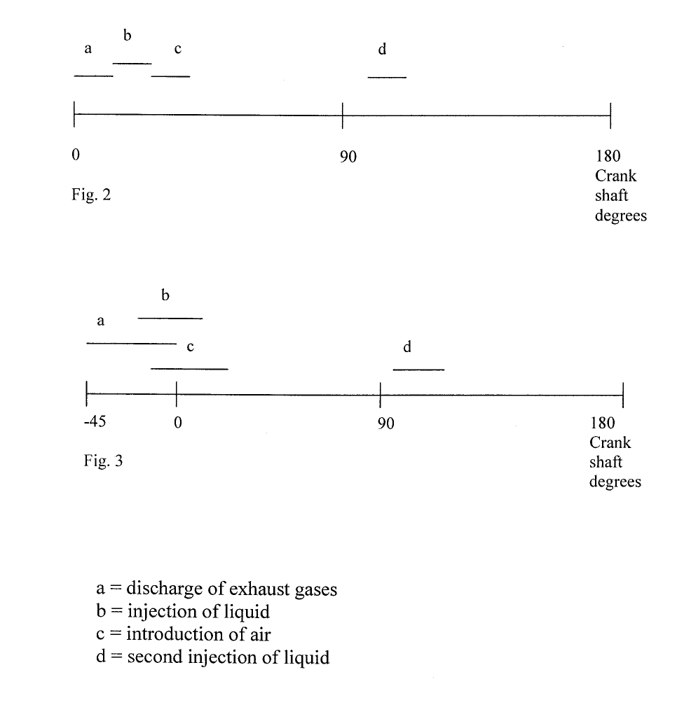

In an operating two-stroke engine, as shown in FIG. 2, the evacuation of combustion gases a, the injection of a liquid other than fuel b and the introduction of air and fuel c may, according to the invention, take place in the following way: At the end of a power stroke, when the piston 2 is in its lower dead centre, the outlet valve 5 is opened for the evacuation of combustion gases that, as a pulse, will flow out of the combustion chamber 3 as a result of the pressure there being substantially higher than in an exhaust gas system or an exhaust gas pipe connected to said outlet. In connection with said pulse, the pressure in the combustion chamber 3 will be lower than in the air supply channel connected to the inlet. At the moment at which the flow of gases out of the combustion chamber 3 ends, the pressure in the combustion chamber 3 is at its minimum, and, in a preferred embodiment, the outlet valve 5 should thereby be closed to stop the evacuation, and, shortly thereafter, the inlet valve 4 should be opened for the supply of air. A time period could, preferably, be permitted between the closure of the outlet valve 5 and the opening of the inlet valve 4, as shown in the embodiment of FIG. 2.

In connection with the ending of the discharge of the exhaust gases, the nozzle 6 is activated for the injection of a liquid, preferably water, into the combustion chamber 3. The amount and composition, and temperature of the liquid should be adopted in order to let at least a major part of the liquid be evaporated immediately upon entrance into the combustion chamber 3, preferably during the above-mentioned time period between the closure of the outlet valve 5 and the opening of the inlet valve 4. As a result of the evaporation, a relative further lowering of the pressure will be achieved in the combustion chamber 3 in comparison to the case in which no liquid would have been injected. A precondition for the supply of a relatively larger amount of air of a given pressure has thereby been generated. It is also a possible option to activate the nozzle 6 while the outlet valve is still open, that is to have a certain overlap between the discharge of the exhaust gases and the injection of the liquid. It is natural that such an overlapping range may become larger at higher rotational speed, in particular if the speed of the relevant valves and the nozzle reaches an upper limit while the rotational speed of the engine is permitted to increase further.

Thereafter, the inlet valve 4 is opened. Since the pressure in the combustion chamber 3 is substantially lower than the pressure in the channel for the supply of air, air will flow as a pulse into the combustion chamber 3 and the pressure in the latter will be increased. The pressure reaches its maximum when the flow of air into the combustion chamber 3 automatically ends, and, in accordance with a preferred embodiment, the inlet valve 4 should be closed in as close connection with this moment as possible. The injection may continue also when the inlet valve 4 is kept open, and may even continue until the inlet valve 4 is closed. However, FIG. 2 shows an embodiment in which the injection of the liquid is ended just before or simultaneously with the inlet valve being opened for the supply of air. It should be mentioned that, during increasing rotational speed, and for reasons discussed above, the previously mentioned time period may decrease and even cease and become substituted by an overlap of the discharge of the exhaust gases and the introduction of air, wherein the injection of said liquid may overlap said discharge as well as said introduction.

As it is further shown in FIG. 2 it is also possible to perform a further, second injection d of said liquid into the combustion chamber 3 by means of the injection nozzle 6 during a later stage of the compression stroke. This time, the object is to achieve an evaporation and, as a result thereof, a relative pressure decrease (in realty a reduction of the actual increase of pressure) and, thereby, a decreased compression work during the remaining part of the compression stroke.

It is within the scope of the invention to open the outlet valve 5 and to open and close the inlet valve 4 within a range of 180 degrees crank shaft angle for the purpose of gas exchange. The range during which this gas exchange takes part will increase with increasing rotational speed in the case when the valves operate with approximately the same speeds independently of the rotational speed. Preferably, the outlet valve 5 is opened at its earliest 90 crank angle degrees before the lower dead centre and closed at the latest 90 crank angle degrees after the lower dead centre. The inlet valve 4 should, under all circumstances, be opened after the opening of the outlet valve 5, but may be closed already before the closure of the outlet valve. There are 180 crank angle degrees between the lower dead centre and upper dead centre.

FIG. 3 shows an alternative embodiment of the method according to invention, which is within the scope of the invention, such as described above. Here, the outlet valve is opened at approximately −45 crank angle degrees, that is 45 degrees before the lower dead centre of the piston 2, and is closed approximately at 0 crank angle degrees. The inlet valve 4 is opened at −10 crank angle degrees and is closed at 35 crank angle degrees. The nozzle 6 is opened at −20 crank angle degrees, that is before the opening of the inlet valve 4, and is closed at 10 crank angle degrees, that is within the time period during which the inlet valve 4 is still open. Accordingly, FIG. 3 shows one of many possible cases of overlapping of the method steps that are conceived according to the invention.

Contemporary freely operable valve openers are electro-mechanically, hydraulically or pneumatically activated. Pneumatically activated valves may, for a given movable mass which is not larger than necessary for the relevant function, and with a lower consumption of energy, reach a certain lift height faster than the other methods of activation. The time passing between the opening of a valve, with said movable mass, to a certain lift height, and the closure thereof may, with pneumatically activated valves, be substantially shorter than the corresponding one for the other of said methods. As there is a need of performing a valve motion as fast as possible, i.e. to open and close with a sufficient area for the evacuation of exhaust gases and for the supply of air for an optimum dynamic effect, the use of pneumatically activated valves is a preferred embodiment of the invention.

The invention also relates to a computer program product stored on a readable computer program medium, for the implementation of the method according to the invention on a combustion engine according to the invention.

The invention is not delimited to constant two-stroke operation but may comprise embodiments wherein two-stroke operation is alternated with four-stroke operation or in which strokes without any combustion take the place of the ordinary power strokes. Accordingly, the invention is assumed to be implemented during the part of the operation which comprises two-stroke operation, or at least during a part thereof.

It should be realized that one and the same cylinder 2 may be provided with a plurality of inlet valves 4 and a plurality of outlet valves 5, as well as a plurality of nozzles 6 for the injection of liquid, wherein, preferably, the outlet valves and/or the inlet valves are provided in the cylinder head. Since the valves, advantageously, are operated by means of pressure fluid and freely operable, there is a possibility of individual control of the valves, and, for example, one of two outlet valves may open before and close before or after the other valve of said pair of valves. In such a case, the discharge of exhaust gases starts at the first moment at which any of the outlet valves is opened and it continuous to the last closure of any one of said outlet valves. This is also relevant for the inlet valves and for the injection nozzles if there is a plurality thereof.

1. A method for the operation of a combustion engine that operates in accordance with the two-stroke principle, which comprises alternating power strokes and compression strokes, wherein the combustion engine comprises at least one cylinder (1) and a piston (2) performing a reciprocating motion in said cylinder, and a combustion chamber (3) delimited by said cylinder (1) and said piston (2), and at least one inlet (13) for the introduction of combustion air into the combustion chamber (3), and at least one outlet (14) for the discharge of exhaust gases from the combustion chamber (3), characterized in that, before or during one and the same compression stroke, a liquid other than fuel is injected into the combustion chamber (3) in connection with the ending of a discharge of exhaust gases out of the combustion chamber (3) and before the start of introduction of air into the combustion chamber (3).

2. A method according to claim 1, characterized in that the injection of the liquid is started immediately after the ending of the discharge of exhaust gases out of the combustion chamber (3).

3. A method according to claim 1, characterized in that the injection of the liquid is started within 20 crank angle degrees, preferably 10 crank angle degrees, or even more preferably 5 crank angle degrees from the ending of the discharge of exhaust gases out of the combustion chamber (3).

4. A method according to claim 1, characterized in that the injection of the liquid is started while the discharge of the exhaust gases still goes on.

5. A method according to claim 1, characterized in that the introduction of the air into the combustion chamber (3) is started while the injection of the liquid still goes on.

6. A method according to claim 1, characterized in that the injection of the liquid into the combustion chamber (3) is ended before the ending of the introduction of the air into the combustion chamber (3).

7. A method according to claim 1, characterized in that the injection of the liquid into the combustion chamber (3) is ended simultaneously with the ending of the introduction of air into the combustion chamber (3).

8. A method according to claim 1, characterized in that at least a major part of the liquid that is injected into the combustion chamber (3) before the start of the introduction of air is evaporated before the introduction of the air is started.

9. A method according to claim 1, characterized in that substantially all the liquid that has been injected into the combustion chamber (3) before the start of the introduction of the air is evaporated before the introduction of the air is started.

10. A method according to claim 1, characterized in that a supply of a fuel to the combustion chamber (3) occurs simultaneously with the injection of said liquid.

11. A method according to claim 1, characterized in that an introduction of a fuel into the combustion chamber (3) is performed with the same valve as the one through which said liquid is injected.

12. A method according to claim 1, characterized in that said liquid is injected together with an alcohol.

13. A method according to claim 12, characterized in that said alcohol forms at least a part of a fuel that is to be combusted in the power stroke following the compression stroke.

14. A method according to claim 1, characterized in that a fuel is supplied to the combustion chamber (3) simultaneously with the introduction of air.

15. A method according to claim 1, characterized in that a second injection of liquid other than fuel is performed during the compression stroke, after the ending of the introduction of air into the combustion chamber (3).

16. A method according to claim 1, characterized in that the liquid generally comprises water.

17. A method according to claim 1, characterized in that the liquid is pressurized and heated before it is introduced into the compression chamber, to such a degree that at least a part of the droplets of the spray will explode spontaneously upon entrance into the combustion chamber.

18. A combustion engine operating in accordance with the two-stroke principle, which comprises alternating power strokes and the compression strokes, wherein the combustion engine comprises at least one cylinder (1) and a piston (2) that performs a reciprocating motion in said cylinder (1), and a combustion chamber (3) delimited by said cylinder (1) and said piston (2), and at least one inlet (13) for the introduction of combustion air into the combustion chamber (3), and at least one outlet (14) for the discharge of exhaust gases from the combustion chamber (3), characterized in that it comprises means (6, 7, 8) for the injection of a liquid other than fuel into the combustion chamber (3) before or during one and the same compression stroke, wherein said means (6, 7, 8) comprises a valve for the injection of said liquid into the combustion chamber (3) and a control unit (8) with a software provided to open the valve (6) in order to inject said liquid, before or during one and the same compression stroke, in connection with the ending of the discharge of exhaust gases out of the combustion chamber (3) and before the start of the introduction of air into the combustion chamber (3).

19. A combustion engine according to claim 18, characterized in that the inlet (13) is provided with a freely operable inlet valve (4).

20. A combustion engine according to claim 18, characterized in that the outlet is provided with a freely operable outlet valve (5).
